(19) United States
(12) Patent Application Publication
(10) Pub. No.: US 2026/0245101 A1
(43) Pub. Date: Aug. 20, 2026

(54) HEALTH GRADE SYSTEM

(71) Applicant: Roger William Hickey, Huntington Beach, CA (US)

(72) Inventor: Roger William Hickey, Huntington Beach, CA (US)

(21) Appl. No.: 19/450,469

(22) Filed: Jan. 15, 2026

Related U.S. Application Data
(63) Continuation of application No. 19/199,101, filed on May 5, 2025.
(60) Provisional application No. 63/759,742, filed on Feb. 18, 2025.

(51) Int. Cl. G06Q 30/018

(52) U.S. Cl. CPC G06Q 30/018

(57) ABSTRACT

A computer-implemented health grading system includes a data acquisition module configured to collect product-related data from multiple sources; a data processing module comprising a data cleaning component and a standardization component to normalize the data; an analysis engine configured to generate a health score based on weighted evaluation of the data using machine learning; and a user interface for receiving product inputs and displaying the resulting health grade.

### CROSS-REFERENCE TO RELATED APPLICATIONS

This application is for a utility patent is a continuation-in-part of a previously filed utility patent having the application Ser. No. 19/199,101, filed May 5, 2025. This application for a utility patent also claims the benefit of U.S. Provisional Application No. 63/759,742, filed Feb. 18, 2025.

### BACKGROUND OF THE INVENTION

### Field of the Invention

This invention relates generally to computerized health analysis systems, and more particularly to a computer-implemented system for evaluating the health impact of a product, via artificial intelligence, to generate a standardized health grade.

### Description of Related Art

There is a need in the food industry for clear and easy to understand information about the health qualities of food products, so that consumers are able to make informed selections of food. There is also a need for a health system that is constantly gathering and analyzing data about food health, and updating the system so that the information provided is up to date and incorporates the latest scientific data.

For the most part, consumers just receive nutrition information on packaging that lists ingredients, and certain basic facts, such as fats, types of fats, amounts of sugars and carbohydrates, and maybe alerts about particularly problematic ingredients to which consumers might be allergic. While this is generally useful, and appears to be transparent, since information is technically provided, this does not provide practical guidance to an ordinary consumer. There is no relative guidance as to the overall healthiness of the product, and this approach does not provide information about the meanings of many ingredients. An ordinary consumer will not know which of the listed chemicals are benign, and which are harmful. Traditional packaging requires a consumer to have a vast knowledge of food chemicals and ingredients to know whether a food product is healthy or unhealthy.

This is compounded by the fact that food product manufacturers actively claim or at least infer that their products are healthy, often with ambiguous terms like “organic” and “natural,” which imply healthiness, but which may be accurately applied to very unhealthy products. Consumers are therefore left confused and easily tricked into consuming unhealthy products that they might otherwise have avoided.

Some efforts are being made to simplify reporting, and apply a simple grade. For example, NUTRI-GRADES® are assigned by the Health Promotion Board, to alert a consumer about the relative healthiness of a product; however, these grades are based upon a very simplistic analysis of foods based upon amounts of sugars and saturated fat. While this is a step in the right direction, it fails to take into account countless other factors, such as preservatives used, and many other additives that might significantly impact the healthiness of the food product.

The prior art teaches basic disclosure of ingredients, and also simplistic grade systems that are rules-based or heuristic-driven, and provide limited information about very basic health factors. However, the prior art does not teach a comprehensive health system that gathers all known health factors available and determines a comprehensive health grade that truly enables a consumer to select healthy products and easily avoid unhealthy options. The present invention fulfills these needs and provides further advantages as described in the following summary.

### SUMMARY OF THE INVENTION

The present invention teaches certain benefits in construction and use which give rise to the objectives described below.

The present invention provides a computer-implemented health grading system that leverages data acquisition, normalization, and machine learning to assign a health grade to products. The system dynamically integrates new research data, evaluates ingredients across multiple health dimensions, and standardizes grading using weighted scoring algorithms.

In one embodiment, the present invention provides a computer-implemented system for determining a health grade of a product. The system includes (a) a data acquisition module configured to collect data related to one or more ingredients of a product from a plurality of sources; (b) a data processing module configured to process the collected data, the data processing module comprising: (i) a data cleaning module configured to improve data quality by performing one or more operations selected from the group of handling missing values, detecting outliers, reducing noise, and normalizing data; and (ii) a standardization module configured to transform the cleaned data into a standardized format suitable for analysis; (c) an analysis engine configured to analyze the standardized data and generate a health grade for the product based on the data; and (d) a user interface configured to receive input related to the product and display the health grade.

A primary objective of the present invention is to provide a health grade system having advantages not taught by the prior art.

Another objective is to provide a health grade system that gathers known health factors and the most current scientific data, and determines a comprehensive health grade that enables a consumer to select healthy products and easily avoid unhealthy options.

A further objective is to provide a health grade system that is able to be dynamically updated using AI to gather necessary data, and analyze the data to determine a health score of a product.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a block diagram of a disease tracking system that incorporates a health grade system according to one embodiment of the present invention.

FIG. 2 is a block diagram of data fusion system utilized by the health grade system.

FIG. 3 is diagram of the operation of the data fusion system of FIG. 1, in one embodiment of the present invention.

FIG. 4 is block diagram of one embodiment of the health grade system of FIG. 1.

FIG. 5 is a perspective view of a first product packaging that includes a grade determined by a health grade system.

FIG. 6 is a perspective view of a second product packaging that includes a grade determined by the health grade system.

FIG. 7 is a flow diagram illustrating the operation of the health grade system, in one embodiment of the present invention.

FIG. 8 is block diagram of one embodiment of the health grade system of FIG. 1.

### DETAILED DESCRIPTION OF THE INVENTION

The above-described drawing figures illustrate the invention, a disease tracking system that incorporates ad health grade system that utilizes artificial intelligence (“AI”) and machine learning (“ML”) to track infectious diseases and other health conditions, forecast their spread, and provide suitable warning and other preventative measures to limit their spread. The system also provides suitable labelling of food and non-food products to alert users to potential health risks posed by those products.

For purposes of this application, the terms “computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used. The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The term “network” is defined to include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines, Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 3G, 4G, 5G, and future access networks may enable wide area coverage for mobile devices. In essence, the wireless network may include any wireless communication mechanism known in the art by which information may travel between computers of the present system.

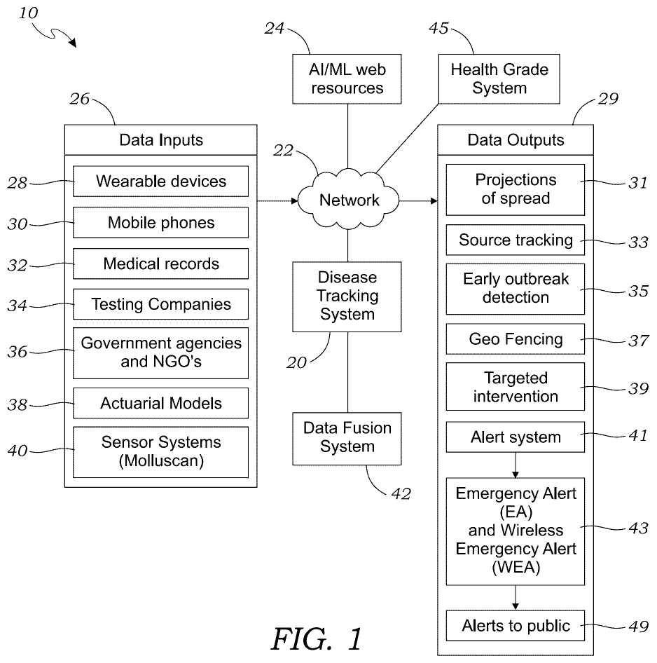

FIG. 1 is a block diagram of a disease tracking and health grade system 10 according to one embodiment of the present invention. As shown in FIG. 1, in this embodiment, the disease tracking and health grade system 10 comprises a disease tracking system 20 that is operably connected via a network 22 with AI/ML web resources 24, to receive data inputs 26 and output data outputs 29. A data fusion system 42 enables the disease tracking system 20 to receive and process the huge amounts on incoming data, so that useful data outputs 29 may be achieved.

As shown in FIG. 1, data inputs 26 may include data received from wearable devices 28 (e.g., smartwatches, fitness trackers, other health monitors, etc.), preferably from a large portion of the entire population. Changes in this data may be an early indicator of a general health problem, such as the spread of a contagion. For example, heart rate variance may move out of normal ranges when the user is first getting ill.

Another data input 26 may include data from mobile phones 30, including movements of the phones, and other data accessible by or generated by the mobile phones 30. Sudden changes is data flows may be indicative of changes in health, and AI/ML is able to extract this form of early warning from seemingly innocuous data. For example, people not going to work on Monday, people going to a hospital or medical center, etc., can all be early alerts to impending global pandemics. Additionally, medical records 32 may be directly accessed, to determine spikes in various illnesses. Testing companies 34 may provide similar data, in various medical tests being run, and the results of these tests.

Similar data may be collected from government agencies and NGOs 36, actuarial models 38, and sensor systems (e.g., Molluscan) 40, each discussed below. The mobile phones 30 (or equivalent) may perform functions such as providing geolocation, activity levels, or other information. Medical records 32 may be provided, which may further encompass statistical data about recent test/examination results, rather than just individual records. Additional data inputs are discussed in greater detail below, which can be collected via AI systems via the Internet or other large networks of data.

Actuarial models 38 integrate actuarial predictions (loss curves, penetration rates) with disease spread simulations so that organizations and governments can implement targeted interventions. The disease tracking system 20 may also implement economic impact models (not shown) so that AI can quantify how disease spread affects specific industries, predicting disruptions and suggesting mitigation strategies to reduce downtime.

Molluscan (sensor systems 40) refers to the monitoring of behavior of mollusks such as mussels, clams, and oysters. By monitoring their open/close rhythms and chemical intake, they can act as natural biosensors. The sensor system can work with smart networks to detect water contamination in real time, and provide alerts to vulnerable ecosystems to prevent outbreaks of waterborne diseases before they infiltrate human populations.

From these data inputs 26, the disease tracking system 20 is able to determine the data outputs 29, which may include, for example, may include early outbreak detection 35, projections of spread 31, source tracking 33, Geo-Fencing 37, targeted interventions 39, and an alerts system 41. The early outbreak detection 35 helps with the identification of disease spread patterns at early stages. Source tracking 33 pinpoints the “ground zero” of a disease or contamination.

As described above, targeted interventions 39 may result from the actuarial predictions and disease spread simulations. Targeted interventions may include closing certain businesses or services, remote work, localized lockdowns, shipping of supplies (e.g., medications) to a particular area, etc.

The alerts system 41 may communicate with an emergency alert (EA) system and wireless emergency alert (WEA) system 43, wherein said communication may process through a related agency before being transmitted as an alert to the public 49. Geo-Fencing 37 assists with providing strategic containment measures, and alerts to vulnerable populations. The combination of elements in data outputs 29 may facilitate disease path mapping, to further combat spread. For example, a pharmacy can ensure they have supplies (drugs, shots, masks, etc.) in advance of an outbreak. On the whole, the system 20 may enable health collaboration in real-time so that doctors, policymakers, and public health systems an receive synchronized updates to react faster.

In one embodiment, the alerts system 41 may trigger one of three “tiers” of alerts. In this example, a red alert indicates life-threatening, widespread emergencies such as pandemics, highly contagious diseases, or major food or water contamination crises. An orange alert may signal localized health concerns such as outbreaks of contagious diseases, regional food recalls, or environmental hazards. A green alert may confirm when a previously issued red or orange alert is resolved and conditions are safe. Obviously, any colors may be used to identify different types of alerts, or different categorical identifies, e.g., numbers, words, etc., and there may be greater or fewer tiers of alerts, depending on the desired use, and related agency and government systems.

Any of the systems described above may include or communicate with machine learning models, which can correlate symptoms, geographic movement, contamination reports, etc. in the case of a disease/virus outbreak. ML and AI may also predict where diseases will spread based on the amalgamated data. Important types of data include: epidemiological data such as infection rates, recovery rates, and mortality rates; demographic data such as population density, age distribution, and social behaviors; environmental data such as temperature, humidity, and climate changes; mobility data such as transportation patterns, social movement, and migration data; and health system data such as hospital capacities, vaccination rates, healthcare interventions. The ML/AI models for prediction may be in the form of time series forecasting models (ARIMA, LSTM, Prophet), regression models (Linear regression, Random Forest, Gradient Boosting), epidemiological modeling+AI hybrid which incorporates known disease models like SEIR (Susceptible-Exposed-Infectious-Recovered) and improves them with machine learning, and neural networks. Further processes of the system 10 are shown and discussed below.

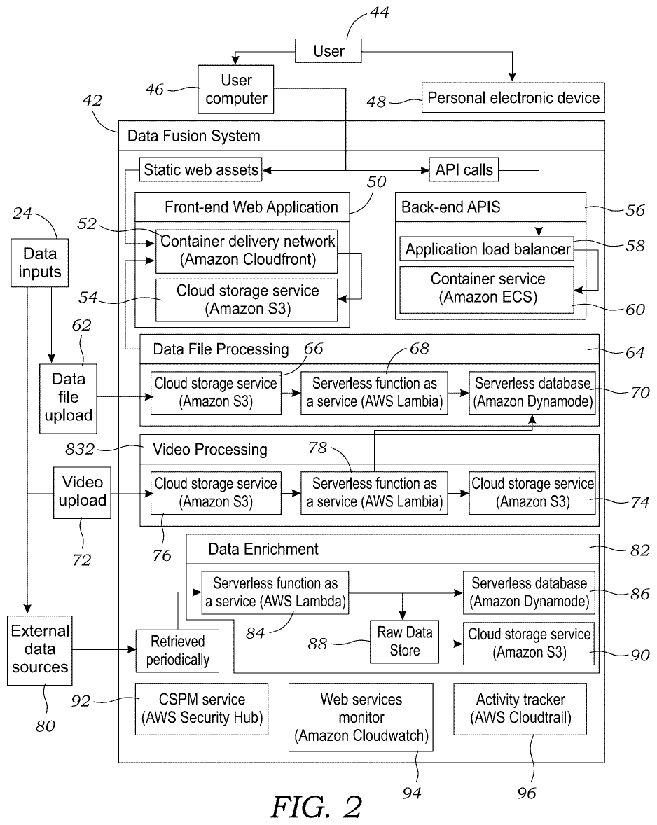

FIG. 2 is a block diagram of data fusion system 42 utilized by the disease tracking and health grade system 10. As shown in FIG. 2, in this embodiment, a user 44 (e.g., administrator) may engage with the data fusion system 42 via multiple options, such as a user computer 46, or a personal electronic device 48 (e.g., a smartphone, desktop, laptop, tablet, etc.), operating, for example, a web site that is configured for accessing the data fusion system 42. The personal electronic device 48 and/or the user computer 46 may access static web assets, API calls, and/or any other methods known in the art.

In one embodiment, the data fusion system 42 includes a front-end web application 50, such as an online dashboard, which includes a content delivery network 52 and a cloud storage service 54. As shown in FIG. 2, the content delivery network 52 directs data flow into the cloud storage service 54. In one example, the content delivery network 52 is Amazon Cloudfront®, and the cloud storage service 54 is Amazon S3®.

As illustrated, back-end APIs 56 may include an application load balancer 58 of an elastic container service 60 (e.g., Amazon ECS®, or a similar or equivalent software solution).

As shown in FIG. 2, a data file upload 62 from one of the data inputs 24 is directed to data file processing 64 that may include a cloud storage service 66 that transfers the data file to an event-driven serverless function as a service 68 (e.g., AWS Lambda®), which transfers to a serverless database 70 (e.g., Amazon DynamoDB®).

Similarly, a video upload 72 may be received in a video processing component 74. It should be noted that the video clip may be any type of clip useful in the invention as-claimed. In this embodiment, the video processing component 74 includes a cloud storage 76 for receiving the video, a serverless function as a service 78 for providing metadata to the data file processing which directs metadata back to the serverless database 70 of the data file processing block, and stores the final video in another cloud storage service 77 of the video processing block.

In an embodiment, external data sources 80 (e.g., information from the internet such as health studies, news, etc.) may be retrieved periodically via a data enrichment component 82. The data enrichment component 82 includes a serverless function as a service 78 that transmits to a serverless database 86, and also through a raw data store 88 into a cloud storage service 90. Information from these sources can be synced with the data file and video file.

As illustrated, in this embodiment, the data fusion system 42 may further include a cloud security posture management (CSPM) service 92 (in this embodiment, AWS Security Hub®), a web services monitor 94 (Amazon Cloudwatch®), and an activity tracker 96 (AWS Cloudtrail®).

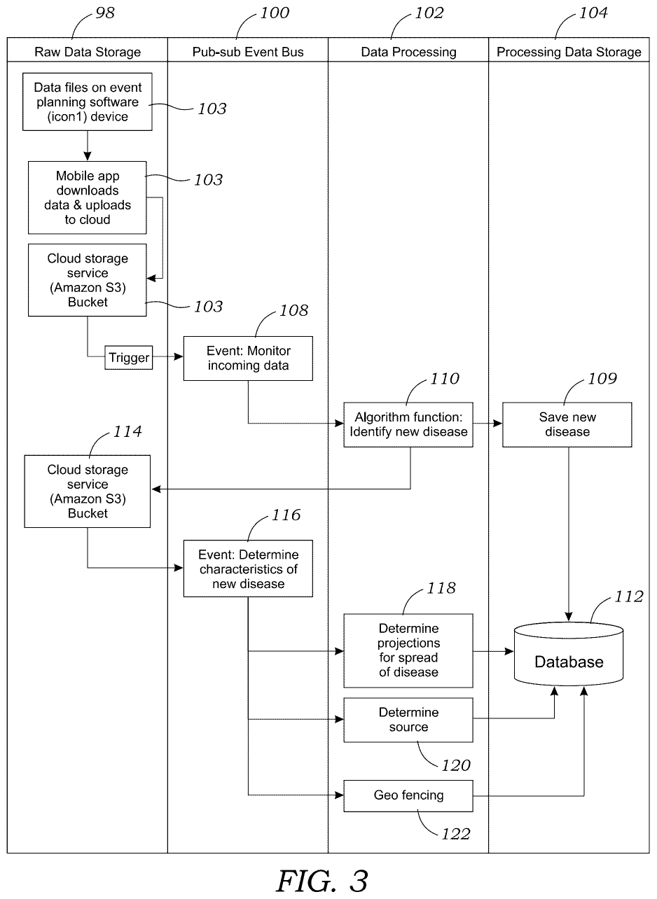

FIG. 3 is diagram of the operation of the data fusion system 42 of FIG. 1, in one embodiment of the present invention. As shown in FIG. 3, data may be gathered from multiple sources, some examples of which are illustrated in FIG. 1. This data may be first subjected to a Whittaker Shannon Interpolation to construct a continuous-time bandwidth function from a sequence of real numbers (e.g., from the data acquired by the various measuring devices).

FIG. 3 is a diagram illustrating data intake, processing, and storage of disease-related information for tracking diseases. The diagram includes steps that move from raw data storage 98, via a bus 100 (e.g., a pub-sub event bus), to data processing 102 and processed data storage 104. First, data files are received 103, such as via an event planning software device (e.g., Icon1®), or via a mobile app, or any other method known in the art. The data is uploaded and stored 105, i.e., in a cloud storage service bucket 106.

This triggers an event 108 being sent via the bus 100, the event 108 being to monitor incoming data, which is sent for data processing 102. The event 108 is processed by an algorithm function 110 for identifying new diseases. If found, the new disease is saved in a database 112 of the processed data storage module 104. A save step 109 is also triggered to store the new disease in a cloud storage service bucket 114 of the raw data storage module 98. This may lead to an event 116 for determining the characteristics of the new disease, the event 116 being created in the pub-sub event bus module 100.

The identified new disease is then processed in data processing 102 to determine projections for spread of disease 118, determine source of disease 120, and Geo Fencing 122. These are all saved in the database 112, or any suitable database.

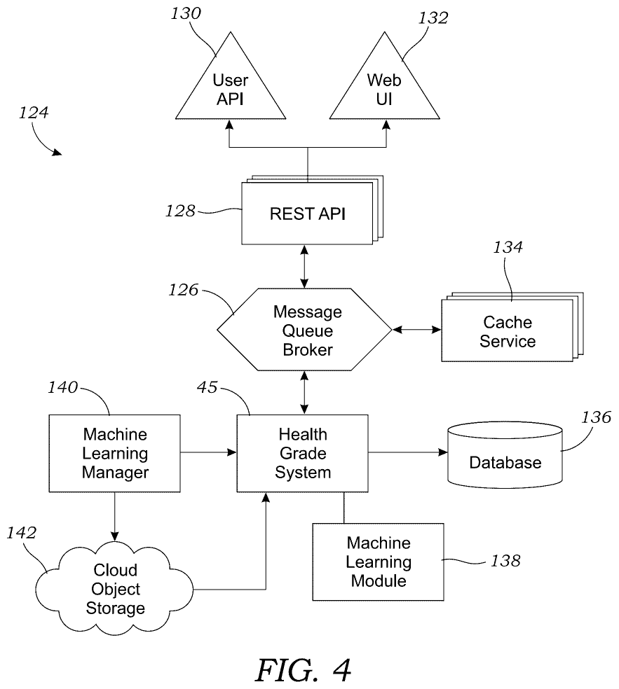

FIG. 4 is block diagram of one embodiment of a backend architecture 124 of the health grade system 45 of FIG. 1. In one embodiment, the backend architecture 124 enables access to a health grade system 45 that embodies a grading system in accordance with aspects of the present invention. As shown in FIG. 1, the backend architecture 124 is based around a communication architecture such as a message queue broker 126, in this case an open source messaging system such as neural automatic transport service (“NATS”), although any form of message queue broker or equivalent system known in the art may be used. In this embodiment, the message queue broker 126 receives outside input via a REST API 128, which provides endpoints for direct interaction with the underlying system. The message queue broker 126 processes incoming requests and facilitates client-system communication. Requests and responses, in this embodiment, use JSON format, but other formats known in the art may be used to interact with consumer APIs 130, a web UI 132, and any other similar or equivalent systems. In this embodiment, NATS messaging is used for broadcasting notifications and receives results related to endpoint request activities.

The message queue broker 126 is also operably connected with a cache service 134 operably engaged with a database 136 that contains cached past predictions, so that the system can determine if the submission has already been received. The cache service 134 avoids wasted computations and improves data access by maintaining a cache of past predictions. The cache service 134 fetches historical predictions from the database 136 but also maintains a time-controlled in-memory cache for more requests. The expiration of in-memory cache items may be, although this is not required adjustable. The service updates the database 136 to flag items requiring model predictions. NATS messaging can be used for processing prediction requests and for updating the in-memory cache with real-time prediction data.

The message queue broker 126 is further operably connected with the health grade system 45, which is operably connected with a machine learning module 138. This is discussed in greater detail below. The health grade system 45 of this embodiment executes prediction tasks using a machine learning manager 140 in an isolated process, communicating with the parent service (e.g., via stdin, stdout, and stderr). The machine learning manager 140, such as MLflow, or any equivalent model management facility, may be utilizing cloud object storage 142, such as Amazon® S3, or any equivalent system to store model and other artifacts. In this embodiment, the service interfaces with the machine learning lifecycle management server, MLFlow or equivalent, to receive model metadata, state, and artifacts of historical and the active model.

Part of this MLFlow orchestration also involves the service interacting with the cloud object storage 142, which serves as a storage location for model artifacts. Instance 0 of the stateful set, acting as a conductor, can synchronize model state information from MLFlow to the local database 136. The database 136 can also be used as a centralized ledger of items from which this service reserves items awaiting model prediction. NATS messaging is used to disseminate prediction results and to also coordinate model change events across disease tracking system instances.

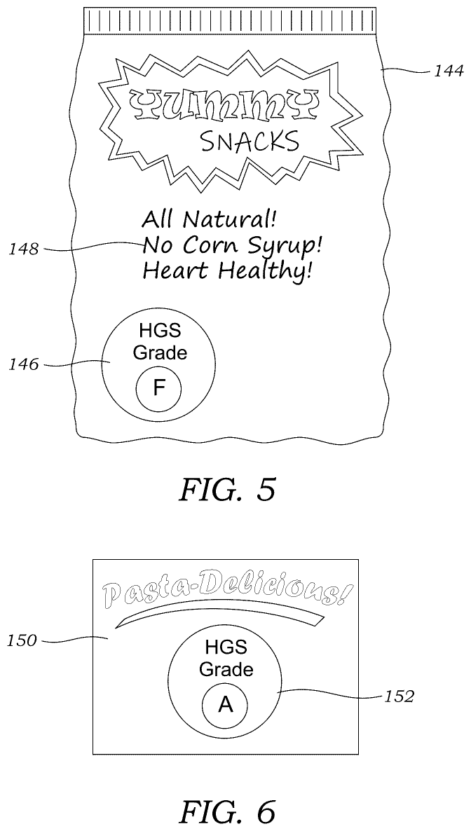

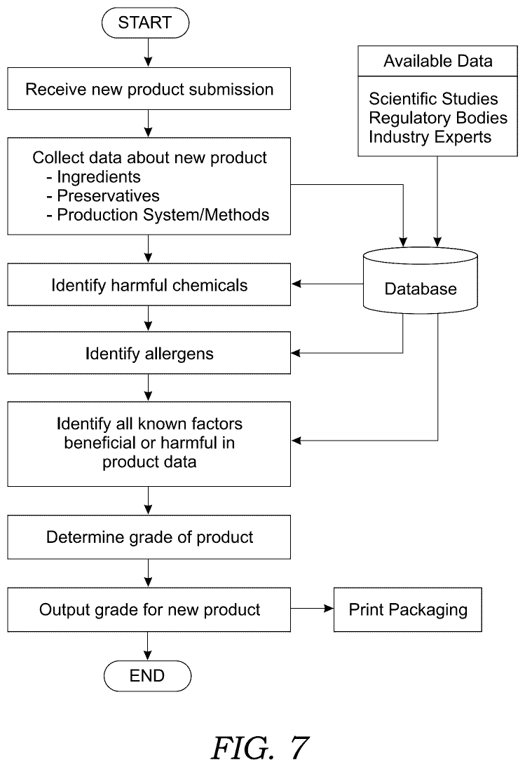

FIG. 5 is a perspective view of a first product packaging 144 that includes a grade 146 determined by the health grade system 45. As shown in FIG. 5, in one embodiment of the health grade system 45, the grade 146 may be determined via a process performed prior to packaging, said process being illustrated in FIG. 7 and discussed below. The first product packaging 144 may display marketing features 148 such health claims, but the grade 146 is irrespective of marketing or claims made by the manufacturer. As shown in FIG. 5, the grade 146 makes it clear that this product is unhealthy, notwithstanding the many positive health claims made.

FIG. 6 is a perspective view of a second product packaging 150 that includes a grade 152 determined by the health grade system 45. As shown in FIG. 6, the second product packaging 150 may not be specifically marketing as a health food, but includes the grade 152 regardless. As shown in FIGS. 5-6, the grades 146, 152 may be provided as A, B, C, etc., but any grading system may be implemented, including numbers, an alphanumeric system, a color system, pictures, and/or any other grading system known in the art. In use, the standardization of evaluating a product's health effects helps consumers to compare products more effectively rather than relying on diverse methodologies of individual companies, apps, etc. As long as the grade system is defined clearly, i.e., A=minimal risk and F=high risk, or similar, any symbols may be used.

FIG. 7 is a flow diagram illustrating the operation of the health grade system 45, in one embodiment of the present invention. As shown in FIG. 7, in one embodiment, the health grade system executes the following process: first, a new product submission is received, i.e., a brand submits a product to be evaluated, or similar. The product may be a food product, but it may be possible to submit other types of products, e.g., cosmetics, pet products, etc. Next, data is collected about the new product. Data may include information about ingredients, preservatives, production systems/methods, or other information. More specifically, the system 45 analyzes additives, preservatives, artificial colors, processing levels, skin irritants, hormone disruptors, toxic compounds, common dietary risks, by-products, nutritional deficiencies, etc. The data may be any information potentially related to the health effects of the product. The data may be stored in a database, which further receives information from other available data sources, e.g., scientific studies, regulatory bodies, industry experts, etc.

At a next step of the operation, the health grade system 45 uses information from the database to identify potentially health-related information, namely, harmful chemicals, allergens, and/or all other known factors beneficial or harmful in evaluating product data. The health grade system 45 may also use AI/ML tools to facilitate automated database crawling. In this process, AI may scan scientific research such as FDA/WHO safety guidelines, ingredient databases (EWG, PubChem, NIH, etc.), and consumer safety reports. The AI tool then continuously updates risk assessments based on new studies, recalls, and regulatory changes. The system 45 may utilize Natural Language Processing (NLP) and ML to extract ingredient toxicity, side effects, and regulatory warnings from academic papers, patents, medical reports, and chemical hazard databases. ML algorithms then predicts long-term health risks based on historical data. Disease factors considered may include ingredients linked to chronic disease such as carcinogens, endocrine disruptors, and the like. Once these factors have been determined, the system 45 outputs a grade of the new product.

In one embodiment, the grade is determined by multiple categories each having scores that are combined in the resultant grade. Different categories may have different scoring “weights” depending on the given algorithm, which is to be precisely determined by an expert in the art. Said embodiment may include a toxicity category that gives a point value to tiers of risk, e.g., high-risk carcinogens such as benzene receive ten points, moderate risk ingredients such as titanium dioxide receive five points, and low risk ingredients such as natural additives receive one point. Another possible evaluated category is disease link potential, with tiers being strong links to chronic diseases (e.g., trans fats) for eight points, moderate links (e.g., high sodium) being four points, and low links (e.g., moderate sugar) being two points. Another possible evaluated category is allergens/sensitivities, with tiers being common severe allergens (e.g., peanuts, gluten for sensitive groups) for six points, and mild irritants (e.g., fragrance in cosmetics) for three points. Another possible evaluated category is processing level (for foods), with tiers being ultra-processed for seven points, moderately processed for three points, and minimally processed for one point. Another possible evaluated category is additives/preservatives, with tiers being artificial additives (e.g., aspartame, BHT) for five points, and natural preservatives (e.g., vinegar, citric acid) for one point.

The total ingredient score may then be added to determine the product grade, as in the following example: A: 0-10 points (minimal risk), B: 11-20 points (low risk), C: 21-30 points (moderate risk), D: 31-40 points (high risk), and F: 41+ points (very high risk). Of course, in other embodiments, different grade assignments may be provided, at different weights/multipliers, and/or for different categories, as determined by one skilled in the art.

Another example of grading criteria follows:
1. acute toxicity: highly toxic (e.g., methanol, formaldehyde) for ten points, moderate toxicity (e.g., ammonia, chlorine) for five points, and low toxicity (e.g., citric acid, vinegar-based) for one point. 2. Chronic health effects: carcinogenic (e.g., benzene, crystalline silica) for ten points, neurotoxic (e.g., toluene, lead compounds) for eight points, and endocrine disruptors (e.g., phthalates, bisphenol A) for six points. 3. Irritation potential (skin, eyes, respiratory): severe irritants (e.g., bleach, lye) for six points, moderate irritants (e.g., alcohol-based solvents) for three points, and low irritants (e.g., plant-based surfactants) for one point. 4. Persistence & bioaccumulation: persistent organic pollutants (e.g., PFAS) for eight points, moderately persistent (e.g., synthetic dyes) for four points, and biodegradable substances for one point. 5. Aquatic toxicity: highly toxic to aquatic life (e.g., nonylphenol ethoxylates) for seven points, moderately toxic (e.g., surfactants in detergents) for four points, and low toxicity (e.g., biodegradable detergents) for one point. 6. Volatile organic compounds (VOCs): high VOCs (e.g., acetone, xylene) for six points, moderate VOCs for three points, and low or no VOCs for one point.

Special considerations for point values may include combined synergistic toxicity of different ingredients, and dilution factors. Scoring weights may be adjusted after assigning number values, i.e., categories 1-3 may have a 60% weight in total score, whereas categories 4-5 have only 30%, and category 6 has 10%, or a similar equation.

Concentration Weight (ingredient's proportion in the product) may be weighted in many different proportions, one example being: Primary Ingredient (50%+)=1.0; Secondary Ingredient (20-49%)=0.75; and Minor Ingredient (5-19%)=0.5.

In one embodiment, the following algorithm is used:

$$Total Risk Score = \sum ( Ingredient Risk Score \times Concentration Weight )$$

In one example of a food product being analyzed by the system 45, different oatmeal products are analyzed, shown below:

Plain Whole Grain Oats (Unflavored Oatmeal): Low glycemic index (good for blood sugar control). High in fiber (beta-glucan), which lowers cholesterol, supports heart health, and improves digestion. Contains antioxidants that help reduce inflammation. May help lower blood pressure and support weight management. Health grade system risk level: Very Low (Healthy Choice). Expected Grade: A

Compare to Instant or Flavored Oatmeal (with Added Sugar & Preservatives): Sugar (increased risk of diabetes, obesity, and metabolic syndrome), Artificial Flavors (possible neurological and allergic reactions), Preservatives such as BHT, Sodium Phosphate (linked to potential carcinogenic effects), Artificial Colors (linked to hyperactivity, allergies, and potential toxicity). Health grade system risk level: High. Expected Grade: C. It should be noted that the example of oatmeal products is intended for the purpose of illustration, and is not to be considered limiting in the variations and applications of the health grade system 45. For example, products other than food may be graded using the system 45, such as sanitization products, makeup products, hair products, etc.

Whichever grading system is used, at a next step, the product manufacturer receives the grade, which ends the process of the system 45. In most cases, the manufacturer would then proceed to print the grade on the product's sales packaging, as shown in FIGS. 5 and 6.

In some embodiments, the system 45 may be associated with a downloadable software application. The software application may allow users to search for individual ingredients and products, wherein users can enter a product name, ingredient, or barcode scan to get an instant grade and risk analysis.

The software application (“app”) may further have AI/ML capabilities for AI-powered alerts and warnings, such as notifications of toxic ingredients, regulatory bans, and health alerts. On the consumer side, the app may further provide alternative product suggestions, recommendations for safer alternatives based on health grades, among other potential features. On the industry side, the app may provide API for manufacturers and retailers, allow companies to check ingredient safety before formulating new products, and enable retailers to display grades in online stores for consumer transparency. Industry professionals may also have access to compliance and regulatory tools, and access to data to help them comply with local and global safety regulations.

The disease tracking and health grade system 10 overall handles real-time analysis across thousands of data points (e.g., health conditions, geographic movements, etc.), and simulates disease spread. A central intelligence layer (i.e.,) interprets inputs across multimedia formats. The system assists with disease containment strategies while safeguarding economic productivity, creating a resilient infrastructure that prevents massive losses due to disease infiltration.

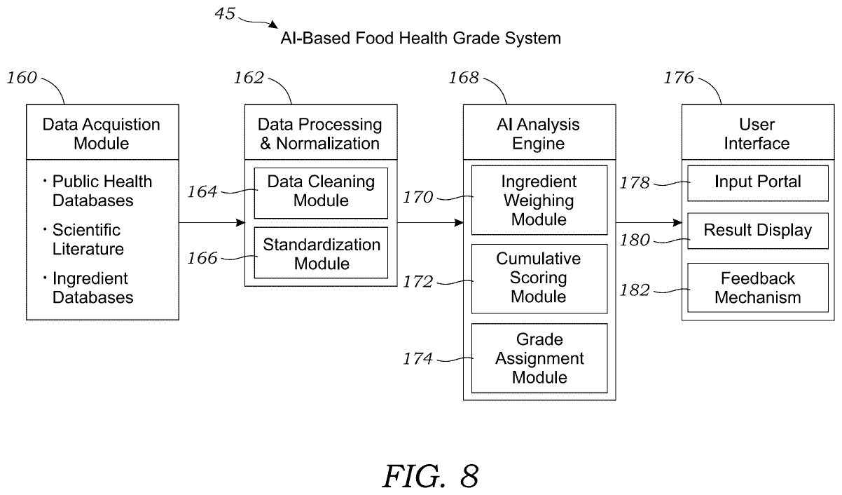

FIG. 8 is block diagram of one embodiment of the health grade system 45 of FIG. 1. As shown in FIG. 8, in one embodiment the health grade system 45 includes a data acquisition module 160, which is used to gather all of the necessary information and data pertinent to the processing of the system 10. In this embodiment, the data acquisition module 160 collects data from a variety of sources, including but not limited to public health databases, scientific literature, ingredient databases, and any other source available. In one embodiment, and AI agent utilizing AI/ML web resources 24 (of FIG. 1) may search the Internet and any other general databases for information that is pertinent to the functioning of the system.

In one embodiment, the public health databases may include USDA, FDA, and/or WHO databases. Scientific literature preferably includes peer reviewed journals and studies, or other databases that have been determined to be accurate and trustworthy.

The data gathered is processed with a data processing and normalization module 162. The data processing and normalization module 162 functions to process the data for use by an AI analysis engine 168. In this embodiment, the data processing and normalization module 162 includes a data cleaning module 164. The data cleaning module 162 is a software-implemented component used to processes raw data to improve its quality, consistency, and usability before the data is used by the AI analysis engine 168 or equivalent AI model or machine learning pipeline. This module performs a series of operations to detect, correct, and remove data anomalies that may negatively impact the accuracy or performance of downstream AI algorithms.

Key Operations Performed by a data cleaning Module include missing value handling, which identifies data entries with absent or null values, and it may also apply imputation techniques (e.g., mean, median, mode substitution, interpolation, or model-based prediction) or removes incomplete entries. Outlier detection and correction detects anomalous data points that deviate significantly from the statistical distribution of the dataset. This flags or replaces these outliers using statistical or machine learning-based outlier detection techniques (e.g., Z-score, IQR filtering, isolation forest).

It may also be used for noise reduction, to filter irrelevant or redundant information (e.g., random errors in sensor readings), and to use smoothing techniques, denoising algorithms, or signal processing methods to enhance data integrity.

The data cleaning module is configured to receive a raw data stream and output a cleaned data stream by applying one or more data refinement operations, the data refinement operations including, but not limited to, missing data imputation, outlier filtering, noise reduction, normalization, format standardization, and encoding of categorical variables, wherein the cleaned data stream is formatted to enhance compatibility with a downstream artificial intelligence model.

A standardization module is also provided, operatively coupled to the data cleaning module, wherein the standardization module receives the cleaned data and applies one or more normalization and transformation operations, including numerical scaling, categorical encoding, and format harmonization, to generate a standardized data stream formatted for use by a downstream machine learning model.

The AI analysis engine 168 that receives the data may include various components for determining a health score from the data. This may include an ingredient weighing module 170 for determining a weight to each ingredient, so that more important ingredients that are more impactful on health are weighted higher than lesser ingredients. A cumulative scoring module 172 may be used to determine the scoring for each product, to determine weighted scores, and then a grade assignment module 174 determines a final grade, as discussed above.

The health grade system 45 may include a user interface 176 for enabling users to interact with the system, including an input portal 178 for receiving user inputs, and a result display 180 for displaying the final grade determined (and presumably the calculations performed that arrived at the grade determined). A feedback mechanism 182 may further be provided, for providing feedback to the AI, for guiding the AI to achieve more accurate results in the case of errors being made, or in case the AI makes incorrect determinations.

Once a product has been inputted into the system via the user interface 176, the AI analysis engine 168 gathers all of the relevant data about the product, its ingredients, potentially other factors such as packaging, preservatives applied, shipping and storage conditions, and any other factors, and makes a determination and outputs a final grade via the user interface 176.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean±/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

1-13. (canceled)

14. A computer-implemented method for health grading of a food or consumer product, the method comprising:
(a) collecting, by a data acquisition module, ingredient-related data from a plurality of sources, including one or more of the following: public health databases, scientific literature, ingredient databases, and Internet-based resources;
(b) processing and normalizing, by a data processing and normalization module operatively coupled to the data acquisition module, the collected ingredient-related data, the processing and normalizing comprising:
(i) cleaning, by a data cleaning module, raw data received from the data acquisition module to generate a cleaned data stream by performing one or more data refinement operations, the data refinement operations comprising at least one of the following:
imputing missing values;
detecting and correcting outliers;
reducing noise;
normalizing and standardizing data formats; and
encoding categorical variables; and
(ii) standardizing, by a standardization module, the cleaned data stream to generate a standardized data stream by applying one or more transformation operations, the transformation operations comprising at least one of the following:
scaling numerical features;
encoding categorical variables; and
harmonizing data formats;
(c) analyzing, by an AI analysis engine, the standardized data stream to generate a health score for the food or consumer product, the analyzing comprising:
(i) assigning, by an ingredient weighting module, respective weight values to individual ingredients based on their health impact;
(ii) computing, by a cumulative scoring module, an aggregate score based on the weighted ingredients; and
(iii) generating, by a grade assignment module, a health grade based on the aggregate score; and
(d) printing the health grade on product sales packaging associated with the food or consumer product.

15. The method of claim 14, further comprising:
presenting, by a user interface, the health grade to a user, the presenting comprising:
(i) receiving product-related inputs from the user via an input portal;
(ii) displaying the health grade via a result display; and
(iii) receiving feedback from the user via a feedback mechanism.

16. The method of claim 15, further comprising:
adjusting, based on the received feedback, future AI analysis performed by the AI analysis engine to improve scoring accuracy.

17. A computer-implemented method for generating a health grade for a consumer product, the method comprising:
autonomously retrieving, by a data acquisition module, ingredient-related data from a plurality of heterogeneous sources, the plurality of sources comprising a public health database comprising USDA, FDA, or WHO databases, and at least one of: scientific literature, ingredient databases, and Internet-based resources;
applying, by a data cleaning module, at least one of Z-score filtering, interquartile range (IQR) filtering, or isolation forest analysis to detect and correct outliers in the retrieved ingredient data, and applying at least one of mean, median, mode substitution, or model-based imputation to replace missing values, to generate a cleaned data stream;
applying, by a standardization module operatively coupled to the data cleaning module, numerical feature scaling and categorical variable encoding to the cleaned data stream to generate a standardized data stream formatted for compatibility with a downstream machine learning model;
transmitting the standardized data stream via a message queue broker operating on a pub-sub event bus architecture to an AI analysis engine, wherein the message queue broker maintains a time-controlled in-memory cache of prior prediction results;
computing, by an ingredient weighting module of the AI analysis engine, a weighted aggregate health risk score by assigning individual weight values to each identified ingredient based on a predefined risk scoring schema encompassing at least two of the following risk categories: acute toxicity, chronic health effect potential, allergen severity, processing level, and additive or preservative classification, wherein the aggregate score is computed according to: Total Risk Score=Σ(Ingredient Risk Score×Concentration Weight);
generating, by a grade assignment module, a health grade by mapping the aggregate score to a predefined grading scale using predefined scoring thresholds, and displaying the health grade via a user interface; and
printing the health grade on product sales packaging associated with the food or consumer product.

18. The method of claim 17, further comprising continuously updating the retrieved ingredient-related data upon detection of changes in the plurality of sources, and triggering reprocessing of previously graded products affected by the updated data.

19. The method of claim 17, wherein the data acquisition module retrieves data from at least two of the following predefined databases: FDA ingredient safety databases, WHO hazard classifications, USDA nutritional databases, EWG ingredient databases, PubChem chemical compound databases, and NIH research literature repositories.
